(19) United States
(12) Patent Application Publication
(10) Pub. No.: US 2013/0081963 A1
(43) Pub. Date: Apr. 4, 2013

(54) Device And Method For Storing Plush Toys

(71) Applicant: Jessica Anderson, Alameda, CA (US)

(72) Inventor: Jessica Anderson, Alameda, CA (US)

(21) Appl. No.: 13/631,187

(22) Filed: Sep. 28, 2012

Related U.S. Application Data
(60) Provisional application No. 61/626,676, filed on Sep. 30, 2011.

(51) Int. Cl. B65D 85/00; B65D 25/54; B65D 51/00; B65D 25/04; B23P 17/00

(52) U.S. Cl. 206/232; 206/457; 29/592; 29/428

(57) ABSTRACT

A new and improved device is disclosed having the form and shape of a large teddy bear or other character and providing an easy and aesthetically pleasing way for children to discretely organize and store their numerous plush toys. One or more viewing windows are provided for viewing into the one or more storage compartments where the plush toys are stored. A recording means allows children to easily record what toys have been stored and where. Access openings at the back of the device make it easy for children to store and remove their toys. Flaps are provided to temporarily cover windows and allow children to discretely store the toys. Methods for making and using the device are disclosed.

### CROSS-REFERENCE TO RELATED APPLICATIONS

This application claims the benefit of US provisional patent application Ser. No. 61/626,676 filed 30 Jun. 2011 by the present inventor.

### FIELD OF INVENTION

The present invention relates to storage device for use by children. Plush toys can clutter up a child's bedroom or family living space and it is sometimes difficult to store them in an organized way that would be acceptable to the children who use and love them.

### BACKGROUND OF INVENTION

Several devices for storing plush toys are known and which allow a child to store toys and other articles. Among these are toy boxes, bags, shelves and drawers. While the known devices provide storage and organization solutions, they fall short in meeting the emotional needs of many children, who may not find these solutions acceptable.

### SUMMARY OF INVENTION

The present inventor recognizes the emotional needs of children to have their beloved plush toys near and easily accessible to them, but also the need to store those toys in a discreet and organized way. Younger children may have difficulty keeping track of plush toys and/or may need a place where they can be stored together and near to them. They tend to lose track of toys stored on shelving or in boxes located across a room. Older children may still enjoy having favorite plush toys near them and easily accessible, but on occasion may not want friends or others to see or know about them. They need a place to discreetly store plush toys out of sight, but to also have the security of having them on a bed or a nearby chair where they can be easily accessed and accounted for. While it may be appropriate and acceptable, in the child's mind, to have one or two plush toys visible as decoration in a room, many older children may feel self-conscious about having many small plush toys out in the open for others to see. Storing the plush toys out of site in a box, bag, or out in the open on a shelf or table simply doesn't accommodate these emotional needs.

For a child, storing toys can be a complex and important task. Many children like to make special accommodations for certain toys. They have favorites and want to store them in a special place. Some children, especially younger children, easily forget that they have stored a toy in a specific place and can experience anxiety when they can't find a special plush toy. They need an easy reminder of which toys are stored where and a way to easily view their stored toys to make sure they are near. Older children are more likely to keep their plush toys in a particular order and/or to establish a hierarchy in placing a certain toy in a certain place. And some children are concerned about organizing their toys in a way that is aesthetically pleasing way and/or a way that is consistent with their fantasies about the toy environment.

In accordance with the invention, the problem of storing plush toys in an organized, discreet and aesthetically pleasing way to the child is solved by a soft storage means which is itself shaped as a plush character or decorative pillow. The storage means may be placed on a bed or near the child having one or more specially decorated compartments in which plush toys may be placed. The storage means may have windows (open or with flap closures) to allow a child to view and account for the stored plush toys. The one or more compartments have means for easy access to allow a child to store or remove a particular plush toy. And a special pocket may contain a card or list of which toys have been stored and in which compartment. In this way, a child may store plush toys in discreet way while still keeping the toys organized, accounted for, readily available and in an environment that is consistent with the child's imagination.

Any features or combination of features described herein are included in accordance with the invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is a front side schematic diagram of a plush toy storage device embodying the principles of the present invention in the form and likeness of a teddy bear.

FIG. 2 is a back side schematic diagram of a plush toy storage device embodying the principles of the present invention in the form and likeness of a teddy bear.

FIG. 3 is a back side schematic diagram of a plush toy storage device embodying the principles of the present invention in the form and likeness of a teddy bear with plush toys placed within each storage compartment.

FIG. 4A is a front side schematic diagram of a plush toy storage device embodying the principles of the present invention in the form and likeness of a train engine.

FIG. 4B is a back side schematic diagram of a plush toy storage device embodying the principles of the present invention in the form and likeness of a train engine.

FIG. 5A is a front side schematic diagram of a plush toy storage device embodying the principles of the present invention in the form and likeness of a flower.

FIG. 5B is a back side schematic diagram of a plush toy storage apparatus embodying the principles of the present invention in the form and likeness of a flower.

FIG. 6 is a flow chart depicting steps associated with making a plush toy storage apparatus embodying the principles of the present invention.

### DETAILED DESCRIPTION

The drawings are for purposes of illustrating several embodiments of the plush toy storage device embodying the principles of the present invention only, and not for purposes of limiting the same.

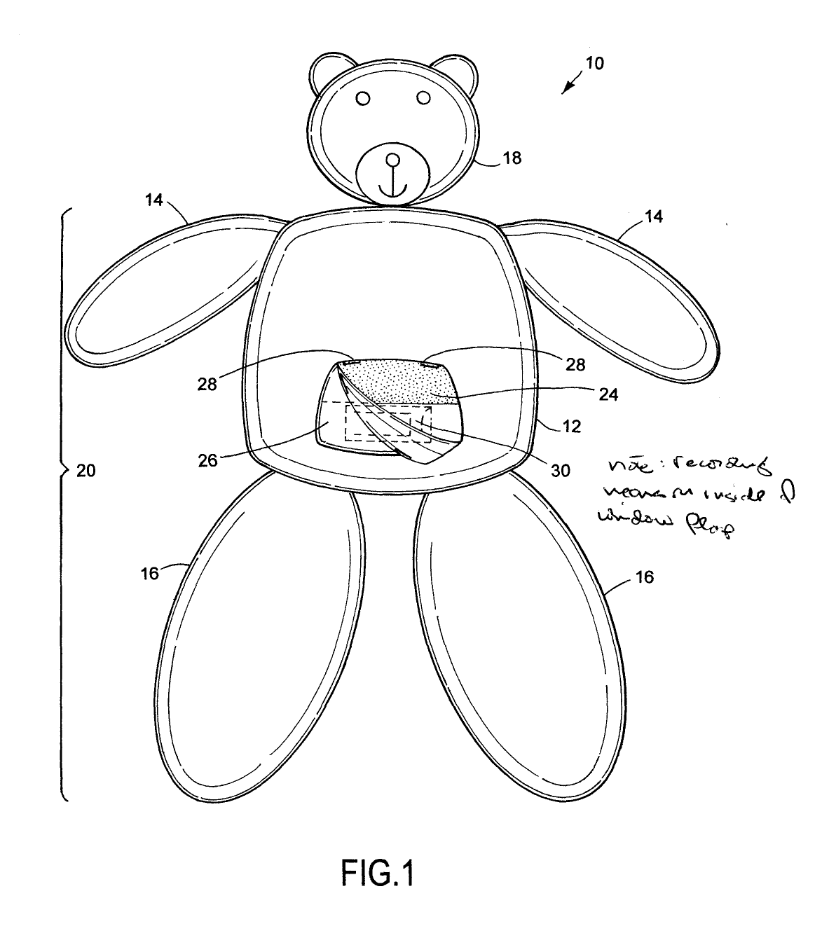

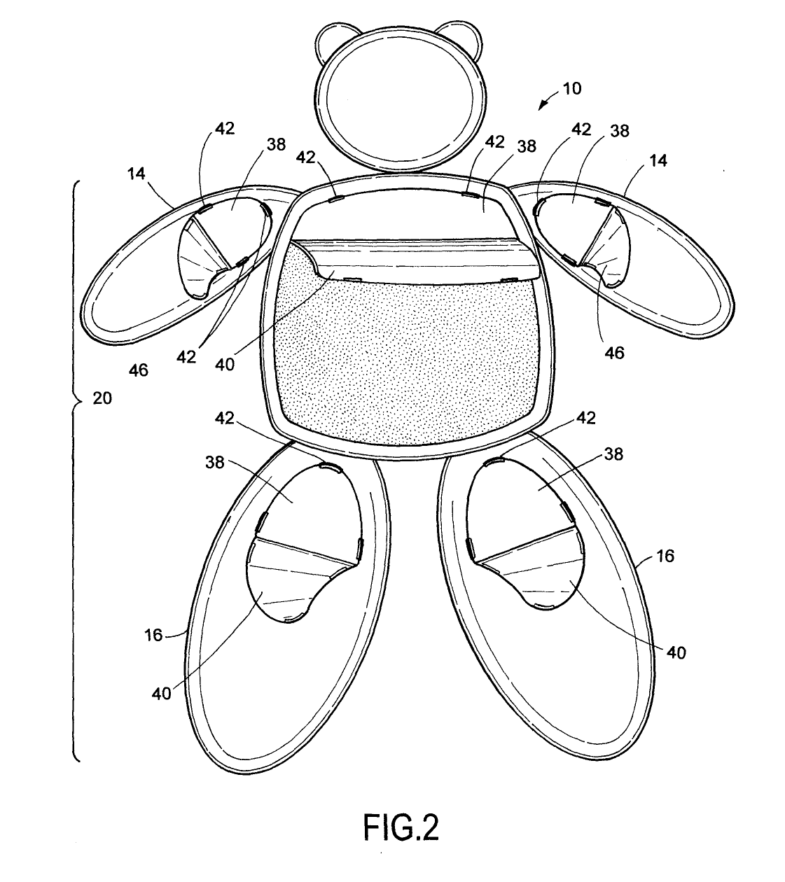

FIGS. 1 and 2 show a schematic diagram of a plush toy storage device embodying the principles of the present invention in the form and likeness of a large teddy bear having two or more sides. When the device is placed on a bed or shelf, the back side may be easily hidden from view. In alternative embodiments, the device may have more than two sides depending on the form and likeness of the character depicted and whether the design is being depicted two dimensionally or three dimensionally. For example, an alternative embodiment of the teddy bear design may be depicted three dimensionally and therefore may be considered to have right and left sides, top, bottom and back sides. But, for purposes of description herein, the teddy bear design depicted in FIGS. 1 and 2 generally has a front and back side and a stuffed head that may be considered to have more than two sides.

The storage device is generally made from materials regularly used for making plush toys. The majority of the outer construction, for example, is generally made of strong, pliable fabrics and material such as stretch velour or polyester microfiber plush. Materials, such as sheet foam, sheet plastic, or cloth may also or otherwise be used. Materials such as fiber or foam fill may be used within the construction to help define and depict the character or shape. Alternatively, and consistent with the principles of the present invention, the device may be formed of relatively harder materials, such as plastic, and covered with a soft matting, material, foam or other material to make it soft and more pliable like a large plush toy. In general, the overall construction and design is meant to look like a large plush toy and therefore materials that are regularly used for making plush toys are most appropriate.

FIG. 1 shows the front side of the storage device (10). The body means (20), in this case, consists of torso (12), arms (14), legs (16) and head (18) in the form and likeness of a large teddy bear. In this embodiment, the torso (12), arms (14) and legs (16) are empty and define one or more storage compartments (22). The head (18) is stuffed with a material generally used in the manufacture of stuffed plush toys and, therefore, is not available as storage space but could, in alternative embodiments, allow space for one or more storage compartments.

The five storage compartments (22) depicted in FIG. 1 are separate and defined by a sewn seams or dividers at the connection between arms (14), legs (16) and torso (12). Alternative embodiments may omit the seams or dividers between the appendages and the torso thus forming one large contiguous storage compartment and/or may utilize dividers or sewn seams to create multiple storage compartments within the torso and appendages. In other words, it is not required for purposes of this invention that each of the appendage or torso portions define a single storage compartment provided that each of the storage compartments is big enough to store a plush toy.

Decorative items and/or indicia consistent with the theme of the depicted character or design (in this case a large teddy bear) may be used on the outside surface of the storage device to define and enhance the aesthetic character. Typical examples of such decorative elements might include ornamental stitching, buttons, ribbons and other fabric, plastic or glass items such as are typically used to define the eyes, ears, nose and mouth of a teddy bear. Other materials used to define clothing or other aesthetic elements may be used on the outside of the device to define the character depicted.

A decorative lining or materials consistent with the theme of the depicted character or design may also be used on or to define the inside surface of the storage compartments. Such lining may be fabric having particular pattern or display a scene that is consistent with the overall intended theme. For example, the teddy bear design as depicted in FIGS. 1 and 2 may have an inner lining that depicts a scene or story consistent with a teddy bear character such as a bear den or other scene. An alternative embodiment of the storage device, for example a storage device in the form and likeness of an automobile or rail car, may have a storage compartments that are lined with fabric depicting images of interiors of automobiles or rail cars. For example, the interior or a rail car design might depict seats, luggage racks or other such items.

The storage device may have one or more window openings (24) made of clear plastic, mesh or other suitable materials for allowing a child to easily look into one or more storage compartments to see the plush toys stored therein. The window openings are generally located on the front side of the device although they may be located on other sides as long as they are readily accessible without having to move the device or access it from the back side. The window opening for the teddy bear embodiment depicted in FIG. 1 is located on the front side at or near the belly of the teddy bear. Using this window opening, a child might easily see into the storage compartment defined by the torso. Alternatively, additional window openings could be located at the front sides of the various appendages to allow a child to easily view the contents of the corresponding storage compartments. The window openings may be made of clear plastic, mesh or other suitable materials.

The window openings (24) may have a window flap (26), which may be used to cover the window opening and keep the contents of the corresponding storage compartment hidden from view. Alternatively, the flap may be kept open if a child wants the contents to be viewable. The window flap (26) as shown in FIG. 1 is made of the same material as the front side of the storage device. One or more window closure mechanisms (28) such as snaps, Velcro or other means may be used to keep the window flap (26) removeably affixed to one or more edges of the window. When a child wants to look in to see which plush toys have been stored within a particular storage compartment, the child may simply and easily open the window flap (26) by accessing the temporary closure mechanisms on the flap edges, pull back the flap and look through the window opening (24) to see inside the corresponding storage compartment. Again, by having window openings (24) with window flaps (26) which may be temporarily affixed to one or more window edges on the front side of the device, a child may view his/her stored plush toys quickly and discreetly without having to move the device or access the one or more storage compartments from the back of the device. Alternative embodiments may include window openings at one or more sides of the device as long as they are easily accessible.

Placement of the window openings may vary depending on the theme, form and likeness being depicted. An alternative embodiment in the likeness of an automobile or rail car, for example, might have window openings located where windows are normally positioned on such automobile or rail car. Alternatively, window openings may be positioned in nonobvious locations so they are less obvious and where a child may more discretely view the plush toys stored within the device.

In alternative embodiments, the window openings may be a slit or pouch opening, a zippered opening or some other type of opening as long as they are appropriate for allowing a child to easily view the plush toys stored within the device. For example, a slit or zippered pouch window opening would be appropriate for use on an embodiment that is in the form and likeness of a stuffed kangaroo with the window opening located on the front side in the usual position of a mother kangaroo's pouch. Alternatively, a zippered window opening may be positioned at the location of a chosen character's pocket or handbag. Any number of window openings may be utilized. There may be one window opening at each storage compartment or multiple window openings for a single storage compartment. Any number of arrangements and character designs may be utilized.

The storage device may have a means for recording (30) the contents and location of the plush toys stored therein. The means for recording may consist of any number of recording means suitable for children such as a writable card, voice recording device, electronic recording device, erasable white board or the like. For the embodiment depicted in FIG. 1, the means for recording (30) consists of a pouch (32) which is sewn into the inside panel of the window flap (26) containing a writable card (34) with erasable marker (36). The recording means may be located on any side of the storage device provided it is easily accessible to a child. The recording means allows a child to easily record and recall the location of the toys which have been stored therein. The means for recording can be a very helpful tool for a child who might be anxious about whether a particular toy has been stored or cannot remember the storage compartment where it has been stored.

FIG. 2 shows the back side of the teddy bear embodiment depicted in FIG. 1. The back side of the device is generally made of the same basic materials as the front side. However, alternative embodiments may utilize a back side (or in this case, panel) made of mesh or transparent material (such as clear plastic) that would allow a child to see the contents of the storage compartment(s) without looking through window openings, accessing the storage compartment(s) or referring to the means for recording.

FIG. 2 shows the five separate storage compartments (22) of a size and shape suitable for storing plush toys, in this case defined by the torso (12), arms (14), and legs (16). Each of the separate storage compartments (22) has its own access opening (38) to allow a child to insert and remove one or more plush toys from a storage compartment (22). In this embodiment, each of the access openings (38) is covered by an access opening flap (40) utilizing one or more access opening closure mechanisms (42) (in this case Velcro hook and loop strips) to allow each access opening (38) to be easily accessed and closed. Alternative embodiments may have more than one access openings for any particular storage compartment.

In alternative embodiments, a storage compartment may have an access opening located on the front side or side other than the back side of the device.

In another alternative embodiment, the storage device may have one or more access openings located on one or more sides of the device. The embodiment depicted in FIGS. 1 and 2 has all access openings on the back of the device because the back side of the device is generally hidden from view when the device is positioned front side up on a bed or shelf. In such cases where the back side is generally hidden from view, the back side may be made partially or entirely of mesh or transparent material which is sewn, glued or otherwise attached at the approximate outside edges to the front side panel. A single access opening may be defined by one or more closeable openings in the backside panel allowing a child to easily insert and remove plush toys from the storage compartment. Alternative embodiments might include multiple access openings and or utilize various closure methods such as ties, Velcro tabs, buttons, snaps, zippers or other temporary closure methods as long as they are easily utilized by children.

Use of mesh material for portions of the backside material (or panel) in the various embodiments has the advantage of allowing a child to easily identify the contents of the device and the specific locations of the stored toys. While alternative transparent materials, such as cloth or plastic sheeting may be used, mesh has an additional advantage of allowing air through the mesh material which would be safer for use in embodiments of the device which have storage compartments large enough to allow small children to crawl inside or otherwise place their head through an access opening. It is generally wise, from a safety standpoint that the access openings be large enough to allow a child to place a plush toy into the storage compartment but not large enough to allow the child to crawl in or otherwise be tempted to place his/her head through the opening. Also for safety reasons, it is preferable that the device constructed to allow a sufficient amount of air to flow through the various storage compartments and that the device be made of fire retardant materials. The back side of the embodiment shown in FIG. 2 has a mesh panel that makes up part of the torso storage compartment. This is the largest of the five storage compartments with the largest access opening and, thus, the use of mesh material is most appropriate in this instance. The remaining portions are constructed of opaque material which is the similar to that used for the front side of the storage device.

Referring again to the general construction of the teddy bear embodiment depicted in FIGS. 1 and 2, the head (18) is a circle shape made of one or more pieces of material sewn together and filled with stuffing materials generally used in the construction of plush toys. Alternatively, the head may be constructed of harder material and/or contain one or more storage compartments.

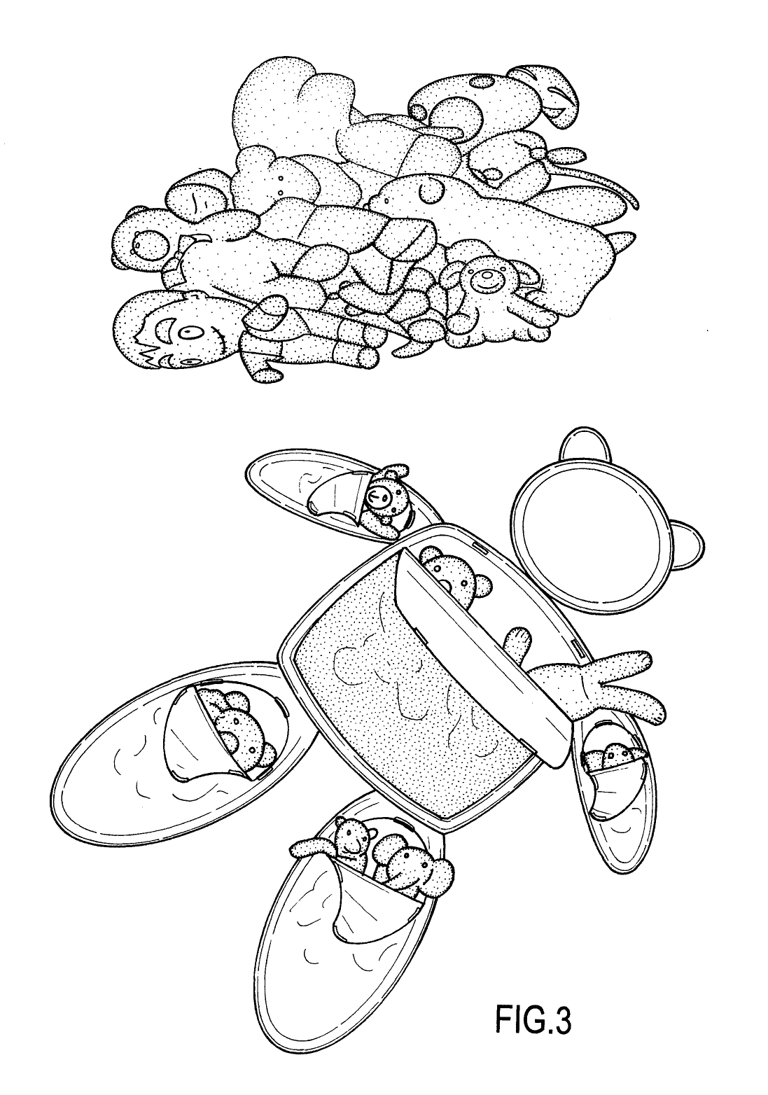

FIG. 3 shows the back side of the teddy bear embodiment of the storage device with plush toys placed in each of the five available storage compartments. In this view the storage compartment flaps are open exposing the plush toys for purposes of illustration. Once a child has placed his/her plush toys within the desired storage compartment(s), he/she may close the access opening flaps and place the storage device front side out on a bed, shelf or other location.

The method for constructing the storage device will depend, in part, on whether the particular embodiment to be constructed has more than one side and the various materials chosen for construction. However, the method for constructing the teddy bear embodiment depicted in FIGS. 1-3 is provided below.

The teddy bear embodiment of FIGS. 1-3 has front and back sides with a round head. The storage means (in this case arms legs and torso) are generally made the same way—with front and back panels of material of roughly identical size and dimension joined together. In this embodiment, the storage means is formed by joining front and back panels including torso, arms and legs. The torso and one or more appendages may be cut separately and joined together or the entire shape including torso and appendage may be cut to form each panel. If the torso and appendages are cut separately, they may be joined together using means generally known in the industry such as by sewing, stitching or gluing them together.

If it is desired that the lining of the storage compartments depict a pattern or scene which is complementary and consistent with the overall theme of the depicted design, the front and back panels will consist of two sides—an inner side with the desired lining and outer side. Indicia such used to define and enhance the aesthetic of the embodiment will generally be on the outside of each panel but could, alternatively, be used on the inside as well.

One or more half-circle (or alternatively) shaped pieces of fabric may be cut from the front panel to form one or more window openings. Correspondingly shaped but slightly larger pieces of material may be joined along a portion of the edge of the window openings to form a window opening flaps which may cover the window when closed. Each window flap is made slightly larger so that it has some overlap over the edges of the window openings when closed. Pieces of clear plastic or mesh in the corresponding sizes and shapes to the one or more window openings may be joined at the perimeter edges of the window openings to form transparent windows. Alternatively, the window openings may be left with no transparent covering. Window closure mechanisms may be attached to the edges of the window flaps where they overlap the open edges of the window openings such that the flaps may be placed over the window openings and removeably attached.

One or more half-circle (or alternatively) shaped pieces of fabric may be cut from the back panel to form one or more access openings. Correspondingly shaped but slightly larger pieces of material may be joined along a portion of the edge of the access opening to form access opening flaps which may cover the access openings when closed. Access opening closure mechanisms may be attached to the edge of the access opening flaps where they overlap the open edges of the access openings such that the flaps may be placed over the access opening and removeably attached.

The front and back panels are laid over one another and aligned such that the corresponding portion of the front and back panels may be easily joined around the perimeter edge. The front and back panels are joined together by any means which generally known in the industry such as being sewn, stitched or glued together.

Other portions of the storage device may be formed and attached to the body means to form the desired form and shape of the character to be depicted. In the case of the teddy bear embodiment, the head (18) is fashioned by joining one or more pieces of material to form a relatively circular head with extending snout or other desired features. Indicia to depict the features of the teddy bear face are affixed to the appropriate pieces of material at the appropriate locations. The head is then stuffed with material generally known and used in the industry and attached to the body means by any known means (such as sewing, stitching or gluing).

Additional steps for constructing various alternative embodiments of the storage device might include attaching foam, sheet plastic or other structural material to the front and/or back panels to provide structural support to the body means. Such construction would have the dual purpose of forming the outer shape of the body means and providing enough structural support that when the one or more storage compartments are empty or not completely fully filled by plush toys, the device will maintain its overall structure and appearance. Such structure will also provide the additional advantage of making the storage of plush toys within the device more discreet because the device will not change its overall volume and shape depending on whether or not plush toys have been stored therein.

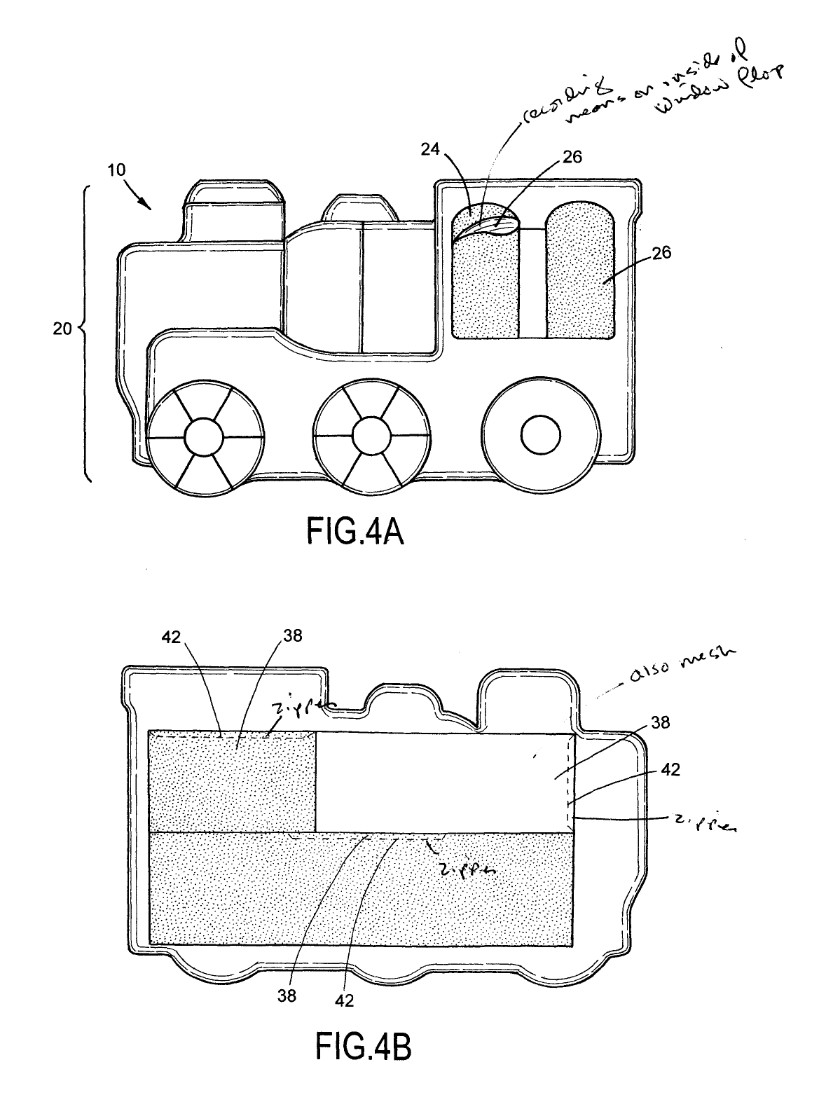

FIGS. 4A and 4B are front and back side schematic diagrams of an alternative embodiment of the plush toy storage device embodying the principles of the present invention in the form and likeness of a train engine. The train engine may be constructed so that it is consistent in theme and generally complementary to one or more other storage devices (for example depicting an engine or other rail cars). The embodiment may be attachable to the complementary storage devices. FIG. 4 A shows a front side panel having two separate window openings (24) covered in this case by window flaps (26) which are stitched to the bottom edge of the window opening and extend upward and may be temporarily attached to the top edge of the window openings using typical temporary closure mechanisms (such as hook and loop, snaps, buttons, zippers and the like). FIG. 4B shows the back side panel made primarily of mesh material that has been attached to the front side panel along the outside edges of the generally rectangular back side panel. Using seams or dividers, the back panel is divided into three separate storage compartments (22), one of which overlaps the window openings so that toys placed in this storage compartment can be seen through the windows when the window flaps are opened. Each of the storage compartments is made of mesh material and has a zippered access opening (38) to allow a child to easily place and remove toys from in each access opening. The contents of each storage compartment may be viewable through the window opening or by looking through the mesh back panel.

Similar to the teddy bear embodiment depicted in FIGS. 1-3, rail engine embodiment may have a means for recording such as a pouch and writable card located at the inside portion of a flap covering a window opening or, alternatively, under a separate flap (i.e. not necessarily covering a window opening) for the purpose of hiding the recording means. Preferably, the means for recording will be located in a discreet location on the front side panel but may be located at other locations or sides that are easily accessible to a child without having to move or turn over the device and access the back side.

The train engine embodiment shown in FIGS. 4A and 4B has window openings positioned in the locations of the windows of the train engine. This allows the child to imagine the plush toys stored within the device as actually riding in the rail car and position the stuffed animals so they can be easily seen through the windows when the window flaps are in an open position and would be hidden when the window flaps are in a closed position. This also allows the child to easily view the stored plush toys and hide the plush toys from view when desired by simply closing the window flaps.

As stated previously with regard to the teddy bear embodiment shown in FIGS. 1-3, the access openings to the storage means may be opened or closed utilizing a variety of closure mechanisms such as Velcro hook and loop, zipper, snap or other such mean. The embodiment shown in FIG. 4B, shows the use of zippered access openings. The use of mesh material to form the back panel and is appropriate as it is preferable for air to flow in and out of the storage compartments for safety reasons as described above. A lining may be used on the back side of the front panel to depict an train scene or compartments within a typical train engine (such as the engineer's cab, the boiler, a coal box and the like) or some other scene which is compatible with the overall theme of a rail engine.

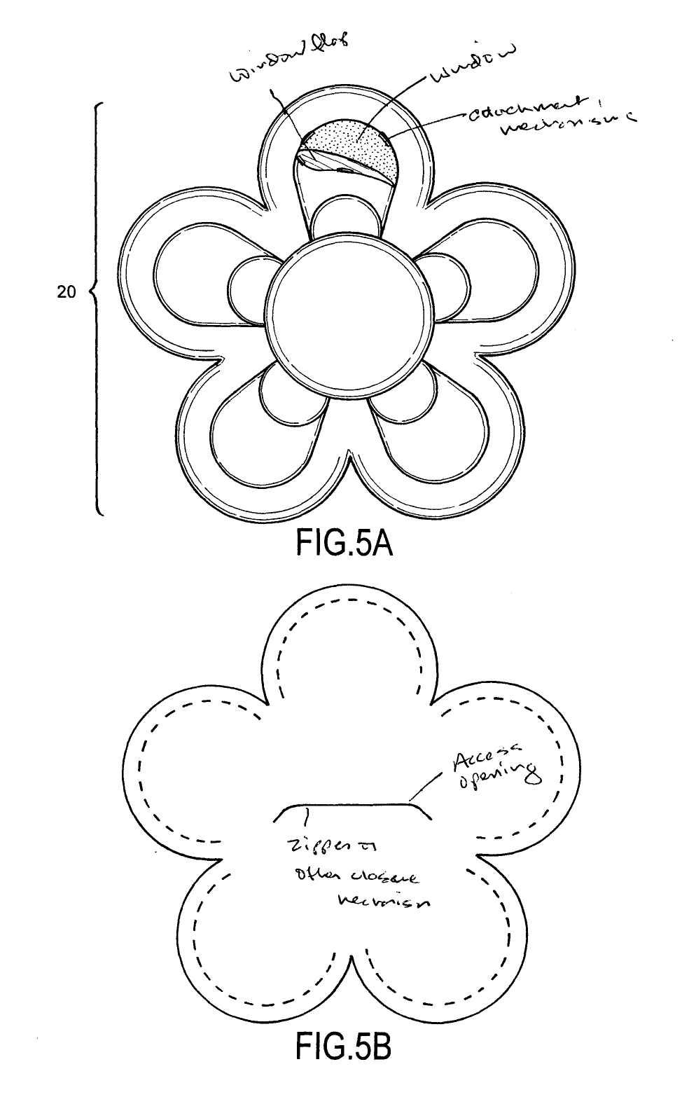

FIGS. 5A and 5B are schematic diagrams showing front and back sides of an alternative embodiment of the plush toy storage device embodying the principles of the present invention in the form and likeness of a flower. In this embodiment, the device is constructed of front and back side panels stitched, sewn or otherwise joined to one another at the peripheral edges of the flower petals with seams or dividers sewn in the back side panel to divide the various storage compartments. The flower likeness is drawn or stitched onto a front panel which is generally in the shape of flowers with 5 separate petals and a circular center. Each of the petals and center define a separate storage compartment as shown on FIG. 5B.

Looking at FIG. 5A, each of the five petals of the flower and the circular center have a window opening located at the front side to allow the child to view whatever plush toy is stored in the corresponding storage compartment. Each of the window openings has a window flap which folds over and covers the window opening. The circular center portion of the flower also has a window opening and window flap covering the window opening. The window flap covering the center opening has recording means consisting of removable and writable card affixed to the inside surface of the window flap for recording the contents of each of the storage compartments.

FIG. 5B shows the back side of the flower embodiment. In this case the back panel is made of a single sheet of opaque material which has been stitched, glued or otherwise attached to the front panel to define separate storage compartments for each corresponding flower petal. In this case each of the flower petal storage compartments is contiguous with and accessible through the center storage compartment. Each of the storage compartments may be accessed individually through separate access openings, or they may be access through the center storage compartment. Again, each of the storage compartments in this embodiment is defined by seams or dividers.

It should be noted that the storage compartment configurations for each embodiments described above are variable in terms of number, size and location. Each of the designs may utilize any number of storage compartment configurations. For example, as described above with regard to the teddy bear design, the storage compartments may be configured within each of the arms, legs and torso, or alternatively may consist of several compartments within the torso or, alternatively, may involve a single contiguous storage compartment consisting of all limbs and torso etc. The configurations may be defined by the seams between the back and front panels or by dividers placed within the storage compartments. Further, it should be noted that storage compartments may be defined by foam or other structural materials affixed to or connected with the front and back panels which would provide structure to the overall device when empty as previously described and to enhance the discreet storage of plush toys because the overall volume and shape of storage device will not depend on whether there is a plush toy stored within.

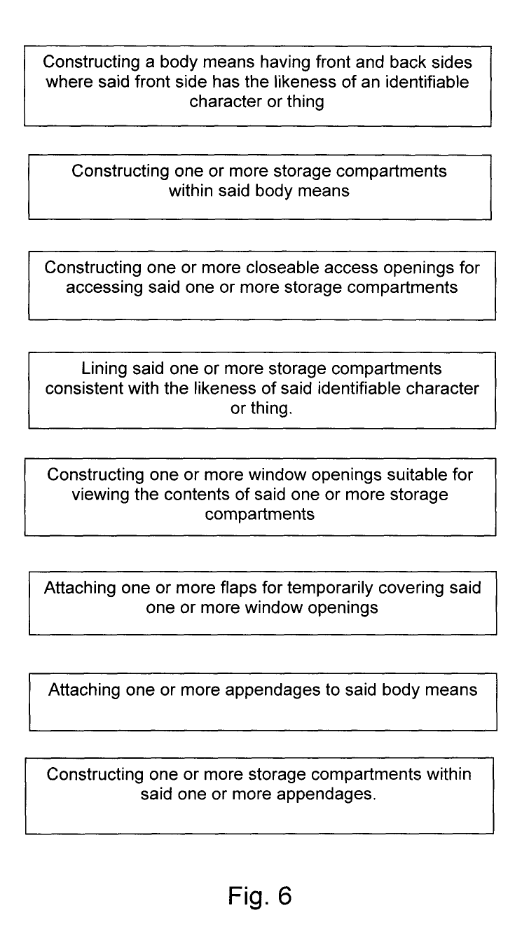

FIG. 6 is a chart depicting steps associated with making a plush toy storage apparatus embodying the principles of the present invention. A particular approach to constructing the teddy bear design has been provided above. But the general steps are provided below.

Constructing body means of one or more panels including front and back panels of material of roughly identical size and dimension joined together by means typical in the plush toy industry. The body means may be fashioned of separate pieces of material joined together or by front and back panels joined at the outer edges. Decorative elements may be attached to the exterior of the storage means to enhance the aesthetic of the character or design depicted in the embodiment.

Attaching inner lining to panels of body means. The inner lining may include decorative elements used to define and enhance the aesthetic of the character or design being depicted in the embodiment.

Constructing one or more window openings in the front and/or, where present, side panel(s). Attaching window opening flaps to the one or more window openings. Window flaps are made slightly larger than the corresponding window openings so that the flap may overlap the edges of the window openings. A transparent material (such as clear plastic or mesh) cut in size and shape corresponding to the size and shape of the window opening may be joined to the edges of the window openings to form windows. Attaching window closure mechanisms to the edges of the window flaps where they overlap the open edges of the window openings such that the flaps may be placed over the window openings and removeably attached.

Attaching recording means to the inside portion of a window opening. Alternatively, the recording means may be located in another easily accessible location.

Constructing one or more access openings at the back side of the device at the storage compartments. Attaching correspondingly shaped but slightly larger pieces of material along a portion of the edge of the access opening to form one or more access opening flaps which may cover the access openings when closed. Attaching temporary closure mechanisms to open edges of the access opening flaps where they overlap the open edges of the access openings such that the flaps may be placed over the access opening and temporarily attached. Note that corresponding closure mechanisms are attached to the open edges of the access openings to allow temporary attachment of the flap over the access opening

The storage compartments may be constructed by aligning front and back panels and joining them at the perimeter edges. Additional seams or dividers may be used to construct additional storage compartments within a larger storage compartment as is generally described above and known in the industry.

Attaching appendages to the body means. Other portions of the storage device may be formed and attached to the body means to form the desired form and shape of the character to be depicted. For example, in the case of the teddy bear embodiment, the head might be fashioned by joining one or more pieces of material to form a relatively circular head with extending snout or other desired features and attaching the same to the torso. Another step would include constructing one or more storage compartments within an appendage and attaching it to the body means. This additional storage compartments may or may not be designed to store plush toys—they may be designed to hold the recording means or other items that the child wants to keep near and with the stored plush toys or other items that a child might typically keep in a room such as books, brushes, non-plush toys and the like.

Additional steps for constructing various alternative embodiments of the storage device might include attaching foam, sheet plastic or other structural material to the front and/or back sides to provide structural support to the body means. Such construction would have the dual purpose of forming the outer shape of the body means and providing enough structural support that when the one or more storage compartments are empty or not completely fully filled by plush toys, the device will maintain its overall structure and appearance.

The above described series of steps for constructing the inventive device do not necessarily need to be performed in the order as described above. For example, the construction of a completed front panel including construction of window opening, attachment of window flap and attachment of recording means may be performed prior to the construction of the storage compartments by joining the front panel to other panels (including back panel). Similarly, construction of a back panel including access openings, attachment of access opening flaps and closure mechanisms may be performed prior to the attachment of the back panel to front panel (or side panels, depending on the particular design being constructed. Further, not all steps need be performed. Some embodiments consistent with the inventive principles may omit one or more elements. For example, a design may omit the window openings or window opening flaps. The order of steps may depend on manufacturing processes typical in the industry and/or be dictated by the particular design, character and form depicted in the design.

A method for using the device would generally include the steps of accessing the one or more storage compartments from the back of the device, storing plush toys with the desired one or more compartments, closing the access openings, turning the device over and placing it on a bed, shelf or other nearby space. The child may use the means for recording for recording what items have been stored in the various storage compartments and where. The child may view the contents of the device by opening a window flap and looking through the one or more window from the exposed front or sides of the device and/or turning the device over and looking through the access openings. If the child wishes to keep the contents of the device hidden, he/she may close the window openings and set the device on a bed, chair or nearby shelf so that the back is facing away from persons who might view the device. The child may use the device as a pillow or place pillows in one or more storage compartments to increase use as a pillow type device and replace those pillows with plush toys as needed and appropriate. The device may be used in a variety of scenarios and ways as one familiar with children and the art may easily envision.

The above described storage device provides a number of advantages over the prior art. One distinct advantage is that it meets the desires and emotional needs of children to have their beloved plush toys near and easily accessible to them, but to also store them in a discreet and organized way. It provides a playful way for children to store their plush toys in a way that is aesthetically pleasing and acceptable to adults. Another advantage is that the storage device allows children to access their toys quickly and easily. They can store and remove them easily. If they want to account for a toy, they can check on them easily by looking through a window opening or by referring to a recording means. Another advantage is that it teaches how to organize by providing them with an attractive and fun approach to storing their toys and recording what they have stored. Another advantage is that the device is portable and a child will find it easier to move than heavy shelving, toy boxes or bins. A major advantage of this device is that it is a kind or plush toy in or itself and a child can snuggle with it or use it as a pillow. The device may also be used to store items other than plush toys. It may be used to store articles or clothing, towels, non-plush toys or other items that are regularly found in a child's room. As one familiar with the industry will appreciate, the device presents advantages which far exceed that of an ordinary toy box, shelf, bin or basket container.

The invention has been described with reference to several a preferred embodiment in the shape and form of a teddy bear and two alternative embodiments. Obviously, modifications and alterations will occur to others upon a reading and understanding of the specification. It is intended by the applicant to include all such modifications and alterations insofar as they are within the scope of the appended claims or the equivalents thereof.

1. A device utilized by children for storing plush toys comprising:
a) a body means made of soft pliable material and having front and back sides;
b) said front side of said body means having the likeness of an identifiable character or thing;
c) said body means having one or more storage compartments suitable for storing plush toys;
d) said body means having one or more closable openings allowing access to said one or more storage compartments.

2. Claim 1 where said one or more storage compartments have an inner lining consistent with the theme of said identifiable character or thing.

3. Claim 1 where said body means has recording means suitable for keeping track of the plush toys stored within the device.

4. Claim 1 where said body means has a window for viewing the plush toys stored within said one or more storage compartments.

5. Claim 1 where said body means is contiguous with one or more appendages which are consistent with the shape of said identifiable character or thing.

6. Claim 1 where said back side is made of a mesh fabric.

7. Claim 5 where said one or more appendages includes one or more storage compartments.

8. Claim 7 where said one or more storage compartments in said one or more appendages has an inner lining consistent with the likeness of said identifiable character or thing.

9. Claim 7 where said one or more storage compartments has one or more closeable flaps over access openings allowing access to said one or more storage compartments.

10. Claim 5 where said one or more appendages includes a head.

11. Claim 4 where said one or more windows is located on the front side of the body means.

12. Claim 11 where said one or more windows is covered by a closeable flap.

13. Claim 3 where said recording means is a pouch holding a card suitable for writing down what has been stored.

14. A method for making a device for storing plush toys comprising:
a) Constructing a body means having front and back sides where said front side has the likeness of an identifiable character or thing, and
b) Constructing one or more storage compartments within said body means.

15. Claim 14 comprising the step of constructing one or more closeable access openings for accessing said one or more storage compartments.

16. Claim 14 further comprising the step of lining said one or more storage compartments consistent with the likeness of said identifiable character or thing.

17. Claim 14 further comprising the step of constructing a window suitable for viewing the contents of said one or more storage compartments.

18. Claim 17 further comprising the step of attaching one or more flaps for temporarily covering said one or more window openings.

19. Claim 14 further comprising the step of attaching one or more appendages to said body means.

20. Claim 19 further comprising the step of constructing one or more storage compartments within said one or more appendages.
